(19) United States
(12) Patent Application Publication
(10) Pub. No.: US 2025/0362212 A1
(43) Pub. Date: Nov. 27, 2025

(54) HEATED VAPORIZER REGULATOR FOR WET GAS SAMPLING AND METHOD

(71) Applicant: MAYEAUX HOLDING, LLC, GONZALES, LA (US)

(72) Inventor: VALMOND JOSEPH ST AMANT, III, ST AMANT, LA (US)

(21) Appl. No.: 18/672,098

(22) Filed: May 23, 2024

(51) Int. Cl. G01N 1/44; H05B 3/08

(52) U.S. Cl. CPC G01N 1/44; H05B 3/08

(57) ABSTRACT

A system for on-stream sampling of pressurized process gas such as natural gas or the like, said system optimized for use with pressurized process gas having liquid entrained therein, or otherwise referenced as “wet”. In the preferred embodiment, a vaporizer-regulator with positive temperature coefficient (PTC) cartridge heater (or alternatively a cartridge employing enhanced Negative Temperature Coefficient technology) to provide an analytically-correct, vapor-only sample to an analyzer or the like, available in a single-step regulation embodiment for single-stage pressure reduction, or to limit Joule Thomson effect condensation, a multi-stage series of regulators for stepped pressure reduction in a radial configuration, the system providing enhanced efficiencies including enhanced energy efficiencies, decreased cost of implementation and maintenance, with significantly reduced complexity and size, when compared to prior systems.

### FIELD OF THE INVENTION

The present invention relates to an improved system and method of sampling pressurized process fluids, and more particularly a system for on-line sampling of pressurized process gas having liquid entrained therein, otherwise known and referred to as multiphase or “wet”, including but not limited to Natural Gas or the like. The much-needed improvement of the present invention replaces the discrete vaporizer with a heated pressure regulator used therewith with a unique, combination vaporizer-regulator with heater for providing an analytically-correct, vapor-only sample to an analyzer or the like utilizing a unique and improved cartridge heater in two embodiments, one employing Positive Temperature Coefficient (PTC) technologies, and alternatively, an improved Negative Temperature Coefficient (NTC) all-in-one cartridge. The present invention is illustrated in a single-step regulator for single-staged pressure reduction, or as an alternative to limit Joule Thomson effect condensation in wet gas or the like, in the form of a multi-stage series of regulators for staged pressure reduction, each of the above providing enhanced efficiencies including reduced energy consumption, decreased cost of implementation or maintenance, in a system having significantly enhanced thermal efficiencies coupled with significantly reduced complexity and size, when compared to prior systems.

### BACKGROUND OF THE INVENTION

Natural Gas is comprised of a mixture of gases (See API 14.1 Section 6.3 and naturalgas.org). Natural Gas is bought and sold based on its heating value (BTU), which is derived from a compositional analysis of the Natural Gas. It is the BTU content that determines the monetary value of a given volume of Natural Gas.

To determine the total heat value of a given volume of gas, a sample of the gas is analyzed, and from the compositional data, its heat value per unit volume is calculated. This value is generally expressed in BTU/cu ft. The typical range of transmission quality gas ranges between 1000 and 1100 BTU/cu ft. Production gas, storage facility gas, NGL, and newfound Shale Gas can have much higher heating values up to or even exceeding 1500 BTU/cu ft.

There has been a long-standing controversy between gas producers and gas transporters regarding measurement of entrained liquid typically present in most high BTU/cu ft gas (rich or wet gas). The unique integral slice capillary probe used in the system of U.S. Pat. No. 10,690,570 allows the extraction of a gas sample containing entrained liquids for analysis of same.

Once extracted, to vaporize a sample comprising wet gas or gas containing entrained liquids, prior art systems (37 FIG. 9, 37′ FIG. 10) typically rely upon a vaporizer heated, monitored and controlled via a complex system comprising a Negative Temperature Coefficient (NTC) temperature sensor for feedback control, a cartridge heater or heater block, a temperature controller, and a thermal cut-off to prevent runaway temperatures should the controller or sensor fail. (see for example A+Manufacturing, Inc January 2006 Genie Vaporizer Product Sheet). Following vaporization, the vaporized sample is sent to a heated regulator to reduce the sample pressure as required by the analyzer, which pressure reduction must be accomplished in a manner which prevents condensation occurring due to JT cooling.

An alternative to NTC heating blocks in prior art vaporizers also includes the use of Positive Temperature Coefficient (PTC) self-limiting BLOCK heaters, such as, for example, the INTERTEC SL BLOCKTHERM brand C24V Self-limiting Block Heater CSA 24, from Intertec Hess Gmbh, Neustadt/Donau, Barvaria/Germany.

Positive Temperature Coefficient (PTC) materials describes those that experience an increase in electrical resistance when their temperature is raised. Materials which have useful engineering applications usually show a relatively rapid increase with temperature, i.e. a higher coefficient. The higher the coefficient, the greater an increase in electrical resistance for a given temperature increase.

A PTC material can be designed to reach a maximum temperature for a given input voltage, since at some point any further increase in temperature would be met with greater electrical resistance. Unlike linear resistance heating or NTC materials, PTC materials are inherently self-limiting and do not require temperature sensors, controllers, or thermal cutoffs, so this material is useful for providing robust and uncomplicated heating elements or the like. PTC products typically may be used for 5-10 years before needing to be replaced.

There have been many applications of PTC heaters for diverse applications including EV car heaters, airplane floor panel heaters, water heater cores, even vaporizer beating elements for battery-powered vapes. A more relevant example of PTC material is the self-limiting heat trace cable such as Raychem (UK patent GB 2199451 A published 1988) as well as others. Non-PTC products like the standard electrical heater cartridges found in prior art heated regulators typically will only have a one-year warranty.

For example, the SL BLOCKTHERM brand C24v Self-Limiting Block Heater from Intertec of Neustadt/Donau, Germany uses PTC elements.

Once vaporized and pressure reduced via one or more pressure regulator stages, the sample has been typically transported to the analyzer by a tube bundle containing self-limiting heat trace cables and stainless-steel tubing.

Applicant's U.S. Pat. No. 10,126,214 teaches the use of Equations of State (EOS) phase diagrams (such as diagram D in FIG. 1) to help the user understand the limitations of prior art heated regulators (some even called vaporizing regulators, including the Applicant's prior art as well as third parties including for example, Tescom, GO, and Swagelok when used with the Applicant's vaporizer. In some cases, the Applicant's prior art 4-stage heated regulator R′ as shown in FIG. 20 was utilized after the vaporizer to provide staged pressure reduction while avoiding excessive Joule-Thomson (JT) cooling and associated condensation risk, to maintain the vaporized sample in the gas phase region through the pressure reduction.

The 4-stage heated regulator R′ provided several unique approaches to solve the JT cooling problem by adding fixed pressure drops to the Applicant's prior art large capacity vaporizer and heated regulator in the form of staged consecutive fixed area pistons which were not adjustable. While an improvement over the prior art, it still required two separate devices, a large capacity vaporizer without an adjustable pressure reduction stage and a heated regulator that did have an adjustable stage but lacked the capacity to vaporize samples containing large quantities of liquid.

Applicant's U.S. Pat. No. 10,690,570 (the contents of which are incorporated herein by reference thereto) taught the use of pressure reducing components (also known as pressure cut) before the vaporization chamber. However, it has been found that in some cases, this technique can result in pre-vaporization flashing, disassociation or fractionation to certain multicomponent Natural Gas sample(s).

Others have incorporated metering valves and other restrictions before the vaporization chamber (See U.S. Pat. No. 11,525,761). While seemingly helping to control flow, it is believed that use of such valves or restrictions may result in pre-vaporization flashing of the sample across the valves, and fractionation of the sample before it enters the vaporization chamber of the device, which may result in inaccurate analysis of the BTU value of the sample. Even the addition of the small diameter loop passageway of incoming sample added to a vaporizer such as shown in U.S. Pat. No. 11,525,761 can be heated by the metal body of the device when it is placed inside a heated enclosure (See US 2023/0280246 A1 and U.S. Patent RE47,478 E1).

Others have provided an alternative cold zone area thermal isolation gap of the vaporizer before the vaporization chamber (See U.S. Pat. No. 11,525,761), when compared to applicant's prior art vaporizer. The thermal isolation gap of the applicant's prior art vaporizer and that taught in the above '751 patent believed ineffective if the vaporizer is in a heated enclosure as, once the vaporizer is in a heated enclosure, the metal temperature becomes at least the enclosure temperature (possibly even the heater cartridge temperature) on both sides of the thermal isolation gap as well as the metal core through it.

The integral slice capillary probe (see for example Applicant's U.S. Pat. No. 10,690,570, there contents of which are incorporated herein by reference thereto) is an improvement to the system and method taught in Applicant's U.S. Pat. No. 10,126,214, for use when the two-phase pipeline fluid sample is not in the dense phase. The integral slice capillary probe can be used instead of bringing the fluid sample to the dense phase with pressure and/or temperature.

While prior art vaporizing regulators may work well for small quantities of liquids entrained and for low flow analyzer requirements, these may not have the capacity to vaporize two phase fluid samples containing large amounts of liquid. The capillary path provided in third party vaporizers or heated regulators may prevent disassociation and fractionation, but they may lack the volume of even applicant's prior art vaporizer, so capacity is limited. Use of the aforementioned INTERTEC brand self-limiting block heater also has a temperature limitation, especially in samples shown by EOS phase diagrams to need higher and/or precise temperature control than the prior art block heater can consistently deliver.

For the same reasons, the other prior art heated regulators mentioned previously (Tescom, Go, Swagelok) all lack the capacity to vaporize two-phase samples containing larger amounts of liquids as indicated by BOS phase diagrams.

Applicant's U.S. Pat. No. 10,690,570 teaches the use of a self-limiting block heater instead of the conventional heater cartridge of the prior art vaporizer. However, the geometry of this solution is not believed conducive to replacing the position and location of the heater cartridge. To compensate for that problem, a brass rod or other thermally conductive rod was joined to the heater block, however, that solution was not efficient in all cases, especially in applications where the large capacity of the vaporizer is needed.

### General Summary Discussion of the Invention

The present invention provides needed improvement of the prior system, combining a unique large capacity vaporizer with an adjustable pressure regulator in both single-stage and multi-stage pressure reduction embodiments, with enhanced efficiency and smaller footprint than the prior art, reducing the space needed in the instrument enclosure, and thereby provide heretofore available space for additional equipment or upgrades as required. Analytical instrumentation space is always a premium and many times is more valuable than money.

Several unique and innovative features of the large capacity vaporizer are realized in the present invention, with others borrowed from prior inventions, including the prior art utilization of a stainless steel wire mesh roll formed to fill the gap between the outside diameter of the heater receptacle and the body inside diameter for heat transfer.

Referring to FIGS. 14-16 in the preferred exemplary embodiment of the invention, instead of metering valves or other restrictions before the vaporization chamber as shown in the general background discussion above, the present invention relies on a capillary flow path 60 of wet gas 63 from the sampling probe 61 to the vaporizer regulator 62 to provide flow control without the need for any valves while eliminating the possibility of premature flashing and sample distortion, while inside the heated enclosure, greatly simplifying the cost for implementation and maintenance of the system.

The present invention does not utilize the “Cold Zone” divider referenced in the prior art systems discussed in the background discussion (above) since the intended use of the metal vaporizer is always in a heated enclosure and the temperature of the entire metal vaporizer on both sides of the divider is the same temperature as the heated enclosure. This saves on machining costs, making the present invention more affordable and available for wider use. The use of the integral slice probe with capillary tubing for sampling and providing flow to the vaporizer prevents disassociation and fractionation of the sample regardless of the enclosure temperature (hot or cold), delivering an analytically correct sample to the vaporization chamber for flash vaporization.

Another improvement is in the use of the new and unique PTC or enhanced NTC heater cartridge for the vaporizer, which includes an integrated temperature sensor and control and thereby removes the need for a temperature sensor from the outlet as in prior art systems, in the case of using the PTC embodiment, removes the need for any temperature sensor completely.

The Equations of State (EOS) phase diagram (such as diagram D in FIG. 1) discussed in the general background discussion of the present application can likewise be used with the present invention to determine when to use the more economical PTC cartridge heater and when the NTC cartridge heater, sensor, cut-off, and controller are needed.

As discussed above, prior art heated regulators have used conventional electrical element wire cartridge heaters which require Negative Temperature Coefficient (NTC) (materials that experience a decrease in electrical resistance when their temperature is raised) temperature sensors and controllers and thermal cutoff protection to protect against runaway cartridge heaters.

The present invention provides an improvement over the prior art NTC block heaters or the like in the form of a plug-in NTC heater cartridge, utilizing a stainless steel or other conducting metal thermal conductor sleeve, the cartridge integrating a built-in NTC sensor, cartridge heater, cut-off, and controller, configured to provide precise temperature control as needed when indicated by the EOS phase diagram, as well as providing an improvement over prior art PTC block heaters such as the SL BLOCKTHERM brand C24v self-limiting block header sold by Intertec Hess GmbH of Neustadt/Donau Germany www.intertec.info.

With its substantially more durable components and reduced complexity, the present invention's PTC heater cartridge embodiment is expected to provide the vaporizer regulator of the present invention an advantage of five to ten times the life expectancy of the aforementioned prior art systems.

The exemplary embodiment of the PTC cartridge of the present invention typically comprises a thermal conductive sleeve of aluminum or the like encasing an off-the-shelf PTC heater cartridge element from DBK USA, Inc of 212 Northeast Drive, Spartanburg, SC 29303 864-599-1600, https://www.dbkusa.com/shop/ceramic-cartridge-heaters-psa, in the form of a tubular metal housing, part number 395211.01, which provides 176° F. at 21W, 266° F. at 38W, and 428° F. at 102W with operating voltage 110-240V, in a compact cartridge heater having a .354″ diameter and 2.95″ length, although it is reiterated this particular configuration is provided for exemplary purposes only, and the particular PTC cartridge utilized can vary depending on the application, equipment, circumstances of use, etc.

The vaporizer regulator of the present invention solves several of the problems discussed in the general background discussion section of the present document. The lower half of the heated vaporizer regulator of the preferred embodiment provides a large-capacity heated flow path, with capacity on par with prior art vaporizers, and can include a metal (stainless steel) mesh screen to provide enhanced heat exchange while filling the gap between the heater receptacle and the body, to maintains its volume and capacity.

The heater receptacle can house the PTC or enhanced NTC heater cartridges referenced above. For the PTC heater, the two wires from the PTC heater cartridge element go through the open end of the heater receptacle to the conduit adapter. The conduit adapter allows the device to have conduit approach from any direction as the adapter can be rotated 360 degrees.

The vaporized sample leaves the large capacity vaporization chamber and flows to the top mounted adjustable pressure regulator section of the device. The lower pressure sample then travels back down into the heated vaporizer portion of the body for post-heat after regulation before leaving the device.

The second embodiment heating means replaces the PTC heater receptacle with an enhanced NTC heater receptacle with built-in controllers as shown below, if the EOS phase diagram shows the need for more precise and/or higher temperature control than the PTC heater cartridge can deliver.

A second vaporizing regulator embodiment replaces the single adjustable stage of pressure regulation with 4 stages of regulation, the last stage being adjustable if the EOS phase diagram shows the need for 4 stages of regulation with heat between the stages of regulation to offset JT cooling and prevent resulting condensation. This third embodiment may utilize the PTC or NTC beater receptacle depending on the EOS phase diagram requirements.

The aforementioned heated vaporizing regulators can be mounted in a system which provides an analytically correct extraction and sample conditioning of the two-phase sample to be delivered to the analyzer.

While the exemplary embodiment of the present invention is presented in conjunction with the capillary probe described in U.S. Pat. No. 10,690,570, the exemplary usage is not intended to be limiting, as the invention as presented herein may be utilized with other sampling systems and methodologies.

In summary, with the integration of the vaporizer and regulator (including multi-stage regulator) into a single unit, as well as the utilization of a PTC or enhanced NTC unit, the present invention provides a heated vaporizing regulator in a much more compact footprint when compared to the prior art, resulting in the creation less required equipment and creation of valuable space 57 within the insulated closure 56 for other equipment or upgrades, as show in in FIGS. 11-13.

### BRIEF DESCRIPTION OF DRAWINGS

For a further understanding of the nature and objects of the present invention, reference should be had to the following detailed description, taken in conjunction with the accompanying drawings, in which like parts are given like reference numerals, and wherein:

FIG. 1 is a Soave-Redich-Kwong EOS chart, illustrating four phase regions of an exemplary hydrocarbon fluid stream sample composition, at varying pressure and temperature.

FIG. 2 is a frontal, side, cross-sectional, partially cutaway view of a first embodiment of the present invention, showing an a single-stage vaporizer regulator with a PTC heater cartridge provided therein.

FIG. 3 is a side view of the invention of FIG. 2.

FIG. 4 is a side, partially-exploded view of the vaporizer of FIG. 3, showing the insertion of a heater cartridge into the vaporizer regulator body.

FIG. 5 is a bottom, partially cutaway view of an NTC heater cartridge which can be utilized with the system of FIG. 4

FIG. 6 is a bottom, partially cutaway view of a PTC heater cartridge which can be utilized with the system of FIG. 4.

FIG. 7A is a frontal, cross-sectional and partially cutaway, first side view of a multi-stage vaporizer regulator alternative embodiment of the invention of FIGS. 2-3, showing first, third and fourth regulator stages of the four total stages provided in the system, the present multi-stage regulator configured to provide stepped-pressure reductions so as to avoid or diminish Joule-Thomson effect condensation of a vaporized sample, the figure further illustrating the preferred PTC heater cartridge of the present invention shown provided therein, as well as the passage from the vaporizer to the first regulator stage, and passage from the third regulator stage to the fourth regulator stage.

FIG. 7B is a frontal, cross-sectional and partially cutaway, second side view of the invention of FIG. 7A, illustrating the second and fourth regulator stages, the staged regulators configured to provide gradual, staged-pressure reductions so as to avoid or diminish Joule-Thomson effect condensation of a vaporized sample, the figure further illustrating the preferred PTC heater cartridge of the present invention shown provided therein, and inlet and outlet passages.

FIG. 8 is a top, cross-sectional and partially cutaway view of the invention of FIG. 7, showing pressure reducers also referenced as modular regulator components 1-3 of the multi-pressure vaporizer regulator of FIG. 7.

FIG. 8A is a top, exploded view of the invention of FIG. 7.

FIG. 8B is a side, cross-sectional view of a prior art modular regulator component.

FIG. 9 is a top, cutaway view of a prior art vaporizer system utilizing a separate heated regulator and required NTC controller.

FIG. 10 is a side cutaway view of the prior art system of FIG. 9.

FIG. 11 is a frontal, partial cut-away view illustrating an exemplary modular conditioning system in an insulated enclosure mounted to a pipeline including a capillary collection probe, the system utilizing a vaporizer regulator with PTC heater cartridge provided therein for heating, illustrating the reduced components required when compared to the prior art system illustrated in FIGS. 9 and 10.

FIG. 12 is a side, partially cut-away view of the invention of FIG. 11.

FIG. 13 is a top, close-up, partial view of the invention of FIG. 11, illustrating the vaporizer regulator component and free space available when compared to the prior art system illustrated in FIGS. 9 and 10.

FIG. 14 is a side view of the invention of FIG. 12 without the enclosure shown.

FIG. 15 is a perspective view of the invention of FIG. 14, without the enclosure shown.

FIG. 16 is a frontal view of the invention of FIG. 14, without the enclosure shown.

FIG. 17 is a frontal view showing the INTERTEC brand PTC option heater block for a prior art heated regulator.

FIG. 18 is a frontal view showing a prior art heated regulator with improved NTC heater block.

FIG. 19 is a cross-sectional view of the applicant assignee's prior art GENIE brand Heated Regulator (GHR) with pre and post heat exchange.

FIG. 20 is a side, partially cross-sectional view of the applicant assignee's prior art GENIE brand JTR multi-stage Heated Regulator, described in U.S. Pat. Nos. 8,220,479, 8,616,228, and 9,588,024, the contents of which are incorporated herein by reference thereto.

FIG. 21 is a side, partially cross-sectional view of applicant assignee's prior art vaporizer that utilizes a controller with built-in thermal cutoff.

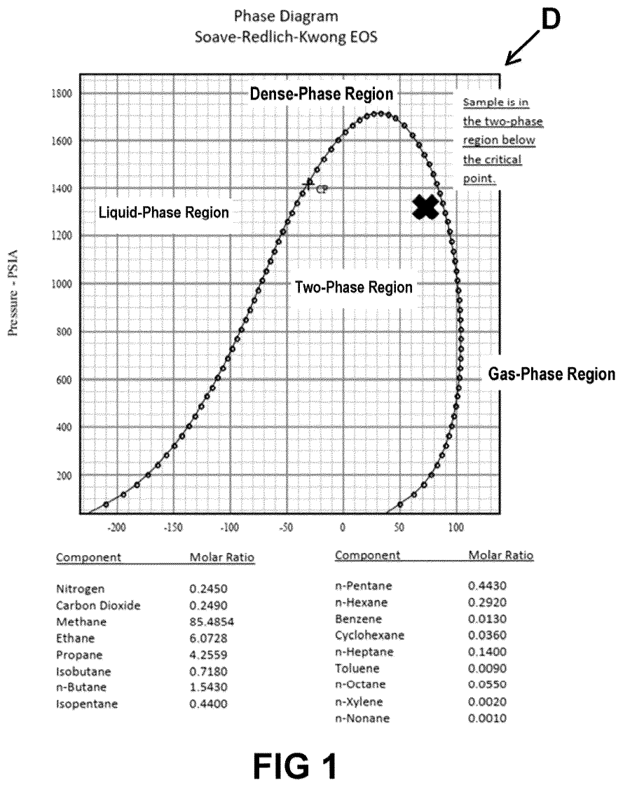

### DETAILED DISCUSSION OF THE INVENTION

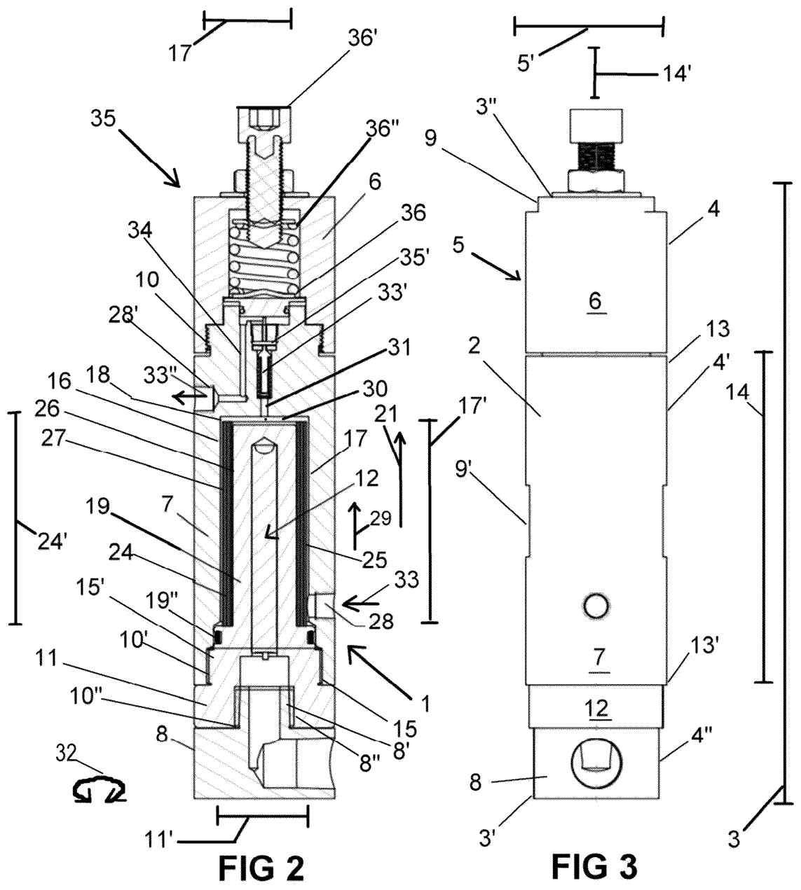

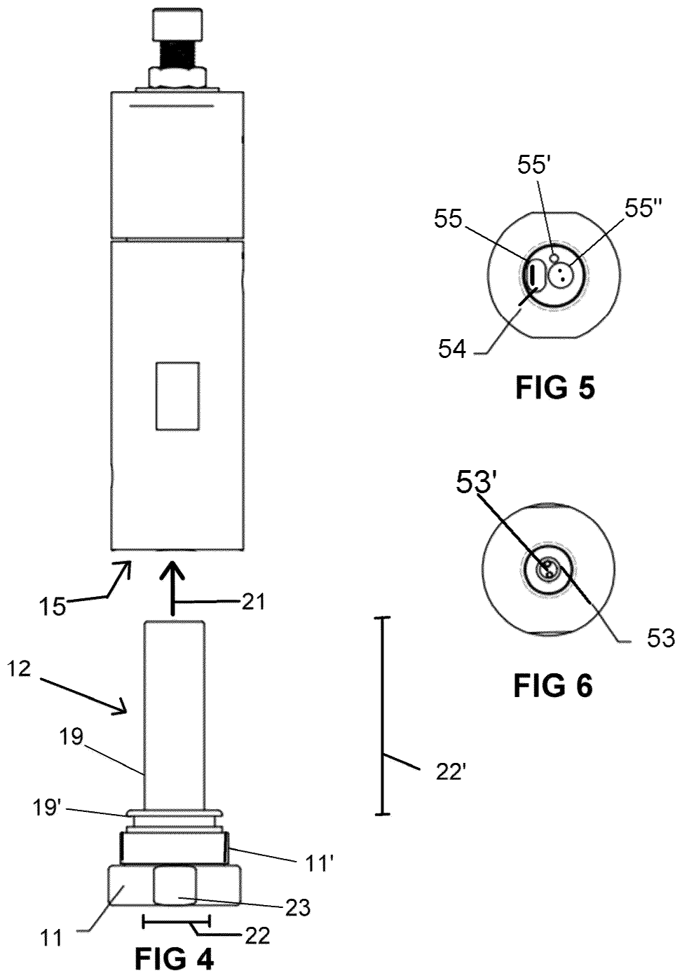

FIGS. 2-6 illustrate an exemplary embodiment of an adjustable single-stage vaporizing regulator 1, has a body 2 having an overall length 3 defining first 3′ and second 3″ends, comprising threadingly 10, 10′, 10″ connected, first or upper 4 and second or lower 4′ sections containing an adjustable regulator 6 and vaporizer 7, the overall (assembled) device shown as having a cylindrical outer surface 5 defining an outer diameter 5′ with wrench flats 9, 9′ formed in the upper 4 and lower 4′ sections to facilitate engagement (and tightening or loosening) via an open-ended wrench or the like.

The lower section 4′ of the body 2 of the present invention has first 13 and second 13′ ends defining a length 14, the first 13 end having a receiver 16 formed therein along its length, said receiver 16 having an inner wall forming an inner diameter 17 and depth 17′ formed to receive 21, via threaded 15′ opening 15 at said second 13′ end of the vaporizer section 7, a heater cartridge 12.

The heater cartridge 12 comprises a threaded 11′ base 11 having an outer wall forming an outer diameter 11′ with a groove 19′ for an O-ring 19″ for a sealed threaded connection with the vaporizer section, the base further having formed thereon and wrench flat 23. The heater cartridge 12 further comprises a thermal conductor sleeve 19 (an aluminum or stainless steel sleeve is used in the present example depending on the type of heater used, although other thermally conductive material could be used depending on the application and circumstances of use), having an outer diameter 22 and length 22′, the thermal conductor sleeve formed to contain therein a heater core, for example, a PTC heating element (FIG. 6) or enhanced NTC heating element (FIG. 5) as will be discussed herein, the depth 17′ of the receiver being sufficient to receive 21 the length 22′ of the thermal conductor sleeve 19 with heater core, so that the space 25 between the outer surface 26 forming the outer diameter 22 of the thermal conductor sleeve and the inner diameter 17 formed by the receiver 16 sidewall forms a vaporization chamber 24 having a length 24′ commensurate with the length 22′ of thermal conductor sleeve 19.

The heater core receives power via the conduit adapter, which engages a cylindrical socket 8″ formed in the heater core base 11 via cylindrical plug 8′ emanating from conduit adapter 8, to facilitate pivotal adjustment 32 as required for the device to have conduit approach from any direction as the adapter can be rotated 360 degrees. As earlier discussed, the PTC heater cartridge 53 is self-regulating so does not require a temperature sensor or cutoff, and includes a built-in power connector 53′ in its base, while the enhanced NTC heater cartridge 54 incorporates a built-in thermal cut-off 55 and temperature sensor 55′ in addition to the power connector 55″.

A screen or mesh 27 formed of thermal conducting material (for example, a Stainless Steel, 60 Mesh Screen roll formed to be situated in the space 25 or gap between thermal conductor sleeve and the receiver sidewall) is thereby provided in the space 25 between the outer diameter 22 of the thermal conductor sleeve enveloping the heater core, and the sidewall forming the inner diameter 17 of the receiver 16, the mesh 27 provided to facilitate enhanced heat transfer via the heater core and thermal conductor sleeve 22 outer surface, to fluid flowing 29 through the vaporization chamber 24.

A fluid inlet 28 is provided at about the second end 13′ of the body 2 of the vaporizer 7 section to receive a flow of fluid 33 (wet gas or the like) and direct same to the vaporization chamber 24 to vaporize entrained liquids or the like and facilitate fluid flow 29 therethrough (contacting thermal conducting mesh 27) utilizing heat emanating from the conductor sleeve 19 via the heater core to facilitate heat transfer to the fluid flowing through the passage forming the vaporization chamber 24, such that fluid flowing therethrough is heated as it traverses the length of the vaporization chamber 24, so as to facilitate the vaporization of any liquids entrained therein to gas, which gas flows out of the vaporization chamber via outflow passage 31 in the vicinity of the first end 13 of vaporizer body 2, via clearance 30 between the distal tip of the conductor sleeve, and distal end 18 of receiver 16 from opening 14. As shown, outflow passage 31 is situated along the longitudinal axis 13′ of vaporizer body 2, and situated between regulator section 6 and vaporization chamber 24.

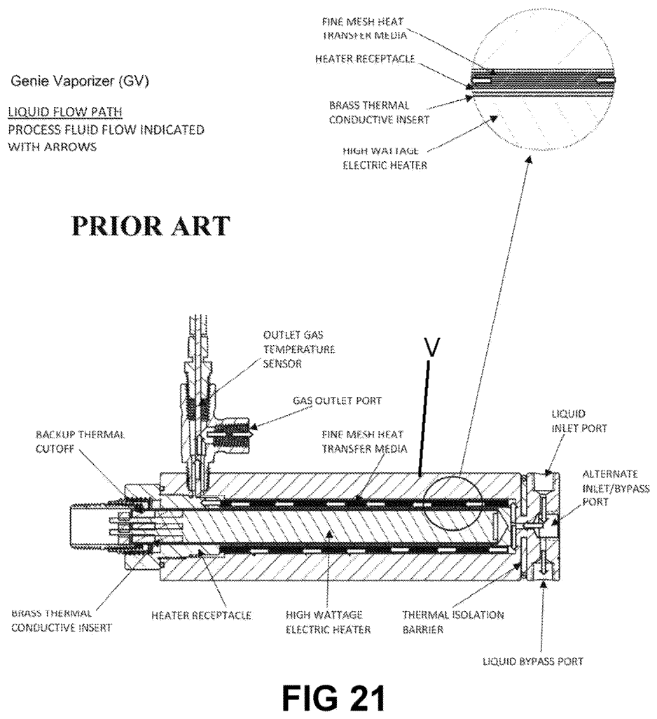

When compared to the applicant's prior art, GENIE brand vaporizer product (distributed by A+Manufacturing Inc and shown in FIG. 21), the vaporizing area for the present device has a comparatively shortened length and does not utilize or require the thermal isolation section shown in the prior art vaporizer device V of FIG. 21

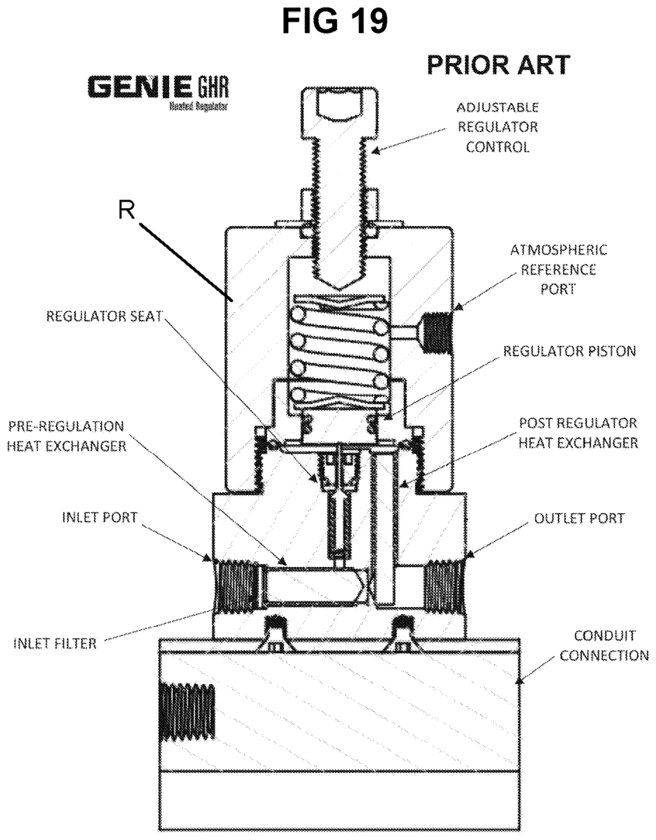

The vaporized sample 33′ leaves the vaporization chamber and flows via to the adjustable regulator section 6 where pressure reduction occurs, so as to provide a regulated, lower pressure sample. The adjustable regulator 35 shown in the present exemplary embodiment comprises a spring biased regulator seat 35′, piston 36 and adjustable mechanism 36′ in the form of a threaded bolt or the like to adjust spring bias of a helical compression spring 36″ applying bias on the piston 36, similar in operation of the prior art GENIE GHR brand heated regulator top regulator R section shown in FIG. 19.

The lower pressure sample then travels back down into the heated vaporizer portion of the body, for post-heat exchange passage 34 after regulation before flowing from the device via outlet 28′, which is situated between regulator section 6 and vaporization chamber 24 so as to receive residual heat from said vaporization chamber for post-heat exchange, and in parallel alignment with post heat passage 31.

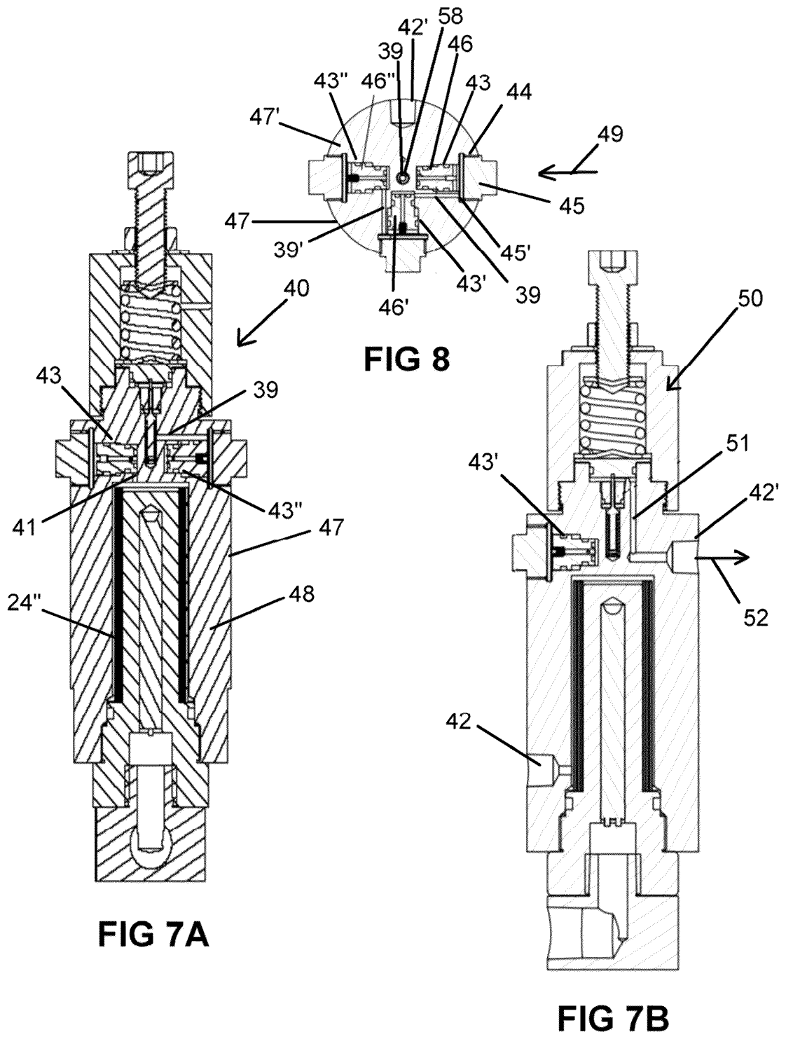

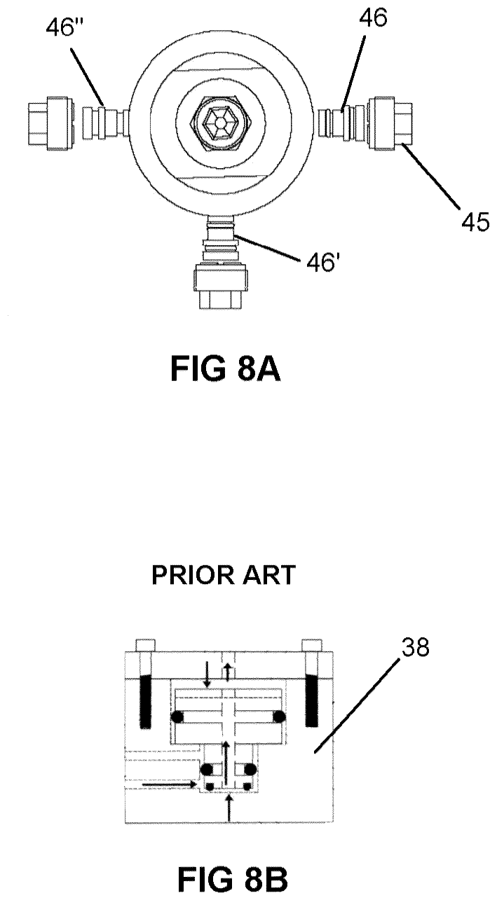

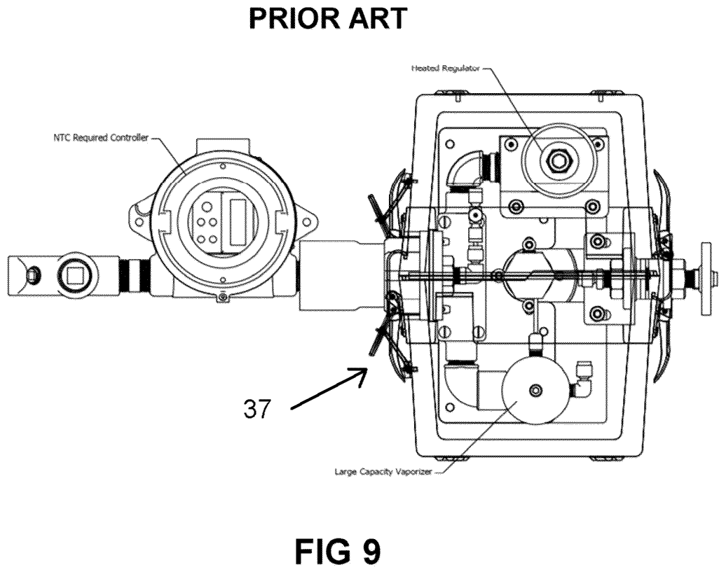

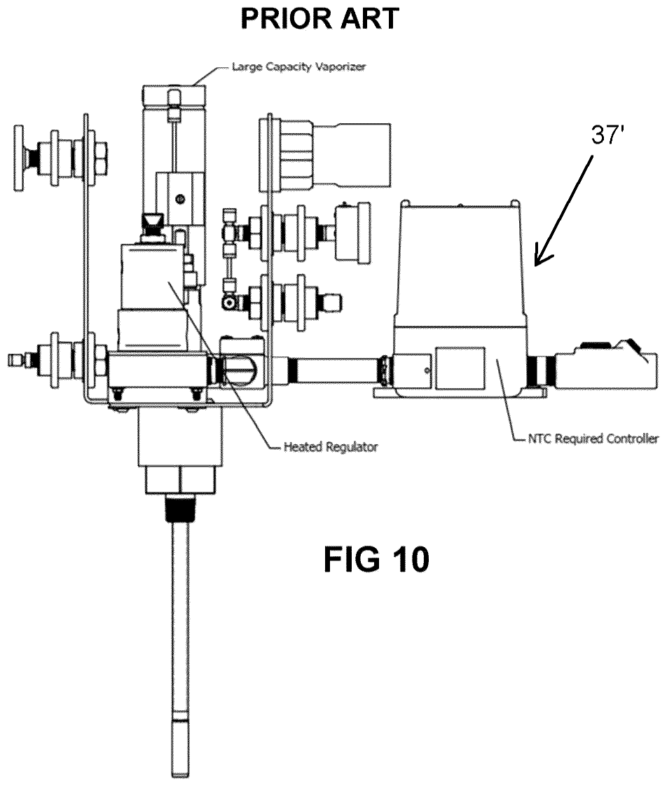

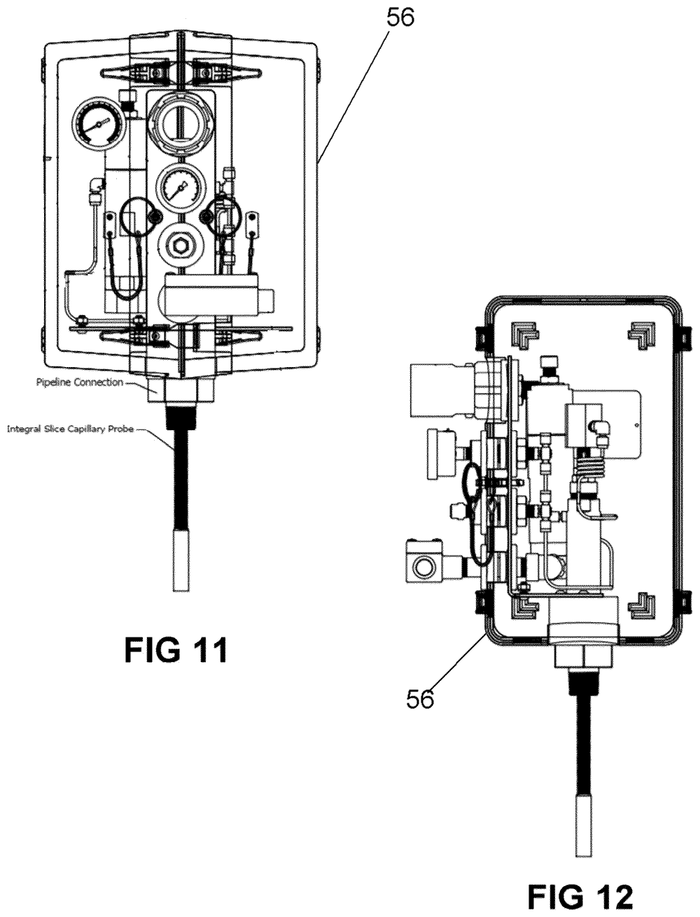

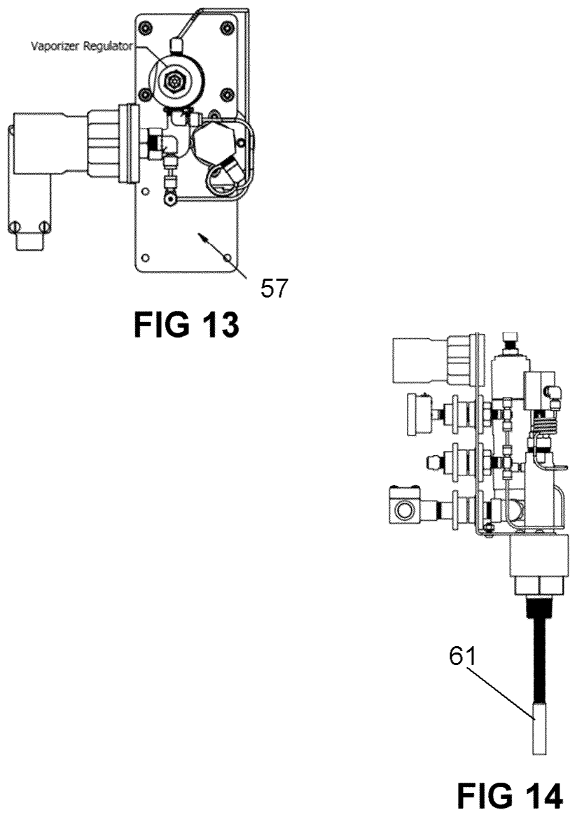

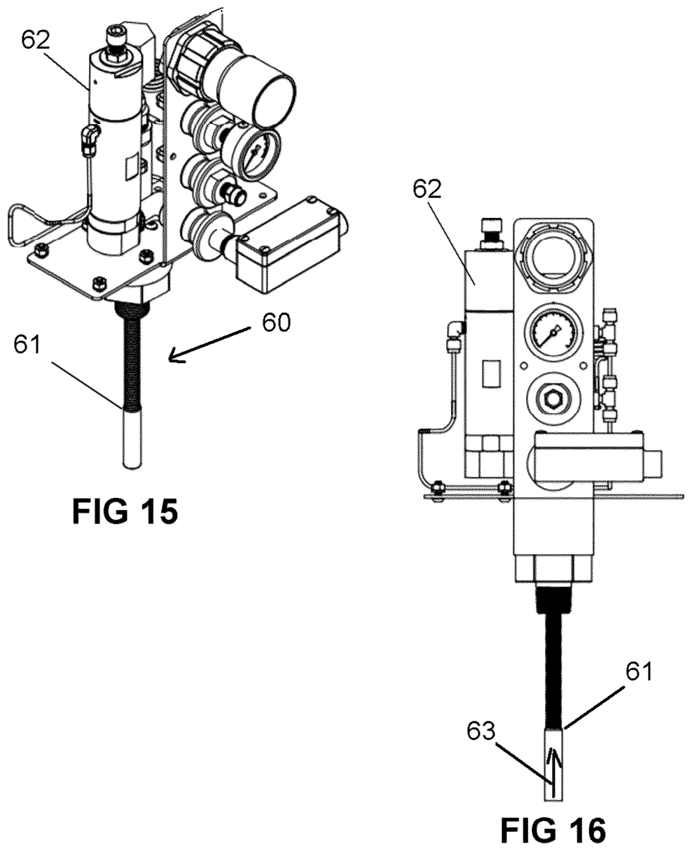

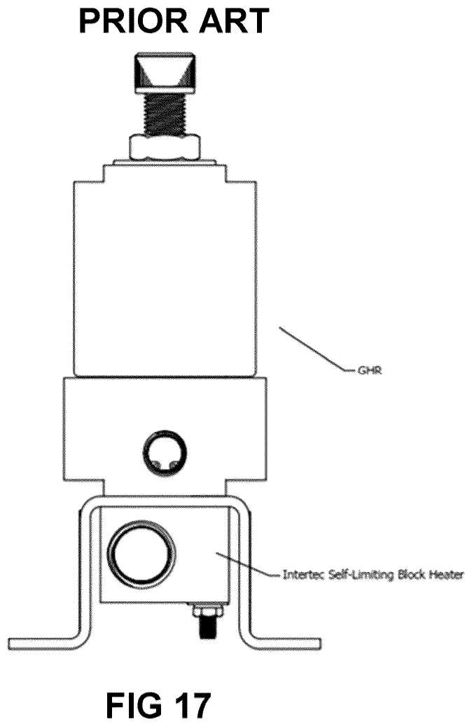

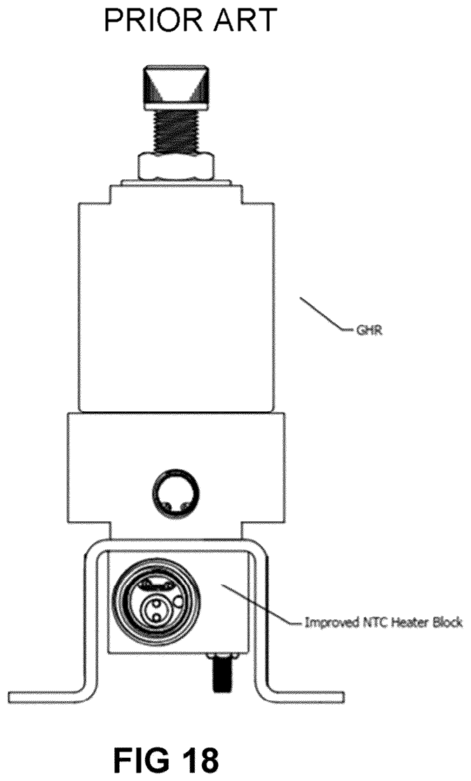

Continuing with the Figures, an alternative embodiment of the single-stage adjustable regulator of FIGS. 2-3 is shown in FIGS. 7A-8A, which illustrate a novel and highly efficient, radially-configured multi-stage adjustable vaporizing regulator 40 having comprising a vaporizer 24 having the same elements and operating characteristics of the vaporizer of the embodiment of the single stage adjustable regulator embodiment of FIGS. 2-3, with the description of same incorporated herein via reference thereto. Of course, it is noted that the dimensions and other specifications regarding the vaporizer can vary depending on the operating characteristics and application.

Continuing with Figure s 7A-8A, a post vaporizer passage 41 emanating from the vaporizer chamber 24″ opposite the inlet 42 provides a short passage of vaporized fluid to the first (stage 1) of four regulator stages, stages 1-3 in a radial positioning relative one another relative to a common center point 58, each stage each comprising piston chambers 43, 43′, 43″ formed to receive modular regulator components 46, 46′, 46″, respectively, the piston chambers 43, 43′, 43″ forming openings along the outer radial surface 47 of the cylindrical body 48 of the device, piston chambers 43, 43′, 43″ situated in serial, spaced relationship relative to one another along common radial plane 47′ and linked via a single passage 39, 39″ from one to the other in series, respectively.

Each piston chamber 43, 43′, 43″ has a threaded opening 44, for receiving a threaded cover 45 with O-Ring 45′ or other seal to provide a sealed chamber, each sized to receive a modular regulator component 46, 46′, 46″ therein respectively, with each said each component 46, 46′, 46″ inserted 49 or otherwise placed in to their respective piston chamber 43, 43′, 43″, and sealed therein via threadingly engaging a respective cover 45 with O-ring 45′ to the threaded opening 44 of each piston chamber.

Applicant assignee's patents U.S. Pat. No. 10,690,570 or U.S. Pat. No. 8,220,479B1, the contents of which are incorporated herein via reference thereto, teaches examples of modular single stage pressure ratio regulator (see for example 38 in FIG. 8b, which is from applicant's U.S. Pat. No. 10,690,570) illustrating the various components and operation which could be utilized in modular regulator component for the present application, although it is emphasized the item illustrated in FIG. 8 is provided to illustrate the general operational characteristics and elements, although the device would have to be configured and sized to fit the present application.

Each pressure reducing component in the form of a modular regulator in the present exemplary embodiment of the invention of FIGS. 7-8A would utilize a reduction piston or the like configured to provide a fixed pressure reduction, selected from a collection similar sized of modular regulators configured to provide various pressure cuts which could be inserted into the piston chamber(s) of the multi-stage regulator. Each modular regulator component of the present invention is selected to provide the desired pressure cut ratio for each stage. The configuration of the piston housing of a particular component may be customized to accommodate both the inside dimensions required to contain the required piston within the piston housing, as well as the outer dimensions required to fit within the chamber to which it to be inserted.

Each modular regulator component 46, 46′, 46″ comprises a piston housing which is formed to receive pressure reducing piston provided to reduce the pressure of wet gas flowing therethrough, providing a pressure cut of the fluid flowing into the vaporizer to facilitate the flash vaporization thereof, providing vaporized gas, which can then be further conditioned downstream, i.e., flowing to pressure regulator (such as an adjustable regulator) as further discussed herein.

Each modular regulator component 46, 46′, 46″ will provide a staged pressure drop or pressure cut of the fluid flowing therethrough, with multiple staged components in series, such as the present invention, to provide a more gradual pressure reduction, to diminish the excessive amount of cooling from taking place in single stage systems (many times the Joule-Thomson (JT) cooling that takes place when a gas is reduced in pressure).

A further advantage of the present “drop-in” modular component feature is that it allows ready customization of the desired pressure drop to facilitate the desired vaporization or other conditioning required, by choosing the appropriate specification pressure reducer component apparatus, which can offer different pressure reduction characteristics while maintaining similar exterior dimensions/configuration. bit with different pressure reduction characteristics, allowing the user to choose the desired pressure reduction characteristic for the particular installation, and insert or “drop in” the appropriate pressure reducer component into the pressure reduction component receiver of the unit.

The first, second, third and fourth regulator stages, stages 1-3, being “drop in” modular regulator components and the fourth being manually adjustable thereby provide customizable, stepped-pressure reductions so as to avoid or diminish Joule-Thomson effect cooling and associated condensation of the vaporized sample flowing therethrough, the figure further illustrating utilization of the preferred PTC heater cartridge of the present invention shown provided therein, as well as the passage from the vaporizer to the first regulator stage, and passage from the third regulator stage to the fourth regulator stage.

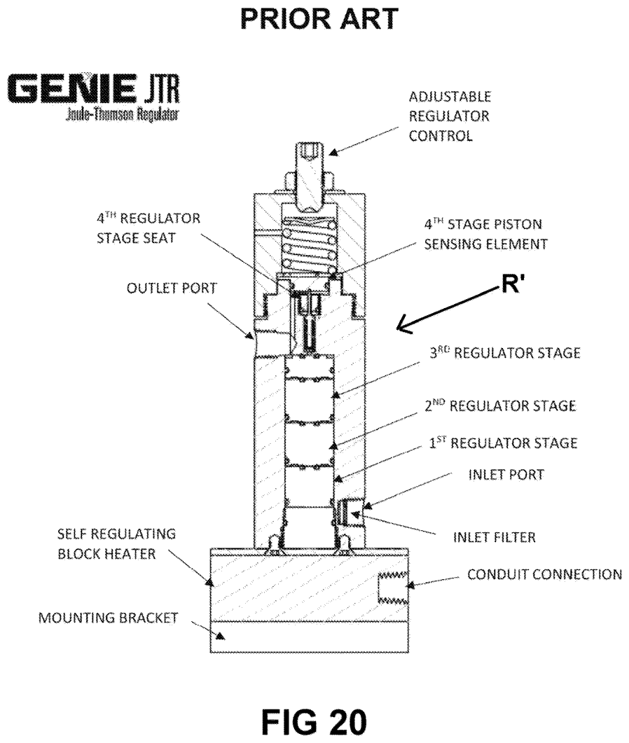

The radial design configuration of stage 1-3 modular regulator components 46, 46, 46″, respectively, of the present invention, are provided in a unique radial configuration situated along a radial plane 47′ just upstream the vaporizer, and below the upper 4 vaporizer body 2 (the body constructed of thermally conductive material such as stainless steel), and utilizes this position intermediate the vaporizer and fourth stage, to exploit the pre-heat characteristics of the treated fluid having just been heated via heater cartridge 12 as well as their physical proximity to same and associated heat zone (as well as exploiting the thermal conductivity of the body 2 to transfer heat from the vaporizer area to the regulator components) provides an enhanced thermal efficiency, as opposed to the prior art which relies upon heat from relatively distant heater block design such as shown in the prior art (for example, see FIG. 20).

Rather, the sample gas is exposed directly to the thermal conductive sleeve 19 or jacket heated by the heater cartridge 20 before reaching the pressure reduction stages, with the distance from the three staged pressure reduction stages and the heater cartridge 12 being minimal AND uniform as to stages 1-3, as opposed to the greater distance of the regulator(s) as provided in the prior art as well as non-uniform heat transfer in prior art due to increasing distance for each stage (for example see FIG. 20 applicant prior art).

The radial design of the present embodiment of the invention of FIGS. 7A-7B and 8 is more efficient for heat transfer than the stacked design of prior art FIG. 20 since the radial design provides uniformity as well as proximity to the heat source. Further, the radial design of the present invention provides easy access of each piston to allow for individual changes and/or maintenance as required, as opposed to having to require disassembly of the entire unit to change or repair an individual regulator stage, or replace O-ring seals as required on an individual basis as in various prior art systems.

In addition, one can simply remove a regulator and enclose the chamber via the threaded cover 45 with seal where reconfiguration, maintenance, or even removal of a particular stage, when a reduction stage is not required.

Following passage through the third piston chamber 43 and associated regulator component 46″ (when used), the reduced fluid then flows via passage 39 to the final, adjustable regulator 50 for a final pressure reduction or regulation, said adjustable regulator 40 having the same components and operation as the adjustable regulator of the single-stage, first embodiment of the invention shown in FIGS. 2-3, above, with the description of same is incorporated herein via reference thereto.

After passage through the final stage (the adjustable regulator 50), the pressure reduced, vaporized fluid 52 flows through passage 51, which passage directs the fluid back toward the heat source, so as to provide post regulator heat exchange of the fluid before it flows out of the device via outlet 42′, which is situated along the same radial plane 47′ as the stage 1-3 regulator components 46, 46′, 46″, respectively.

### Exemplary Specifications

### Exemplary Regulator Spec for Single Stage Vaporizing Regulator:

Upper section: 2″ OD, length 2.2″
Lower section: 2″ OD, length 5,4″
Inlet: ⅛″ 27 NPT, Outlet ⅛″ 27 NPT

### Exemplary Specs for Each of Four Stage JT Staged Vaporizing Regulator:

Upper section: 1.98″ OD, Length 2.2″
Lower section: 2.6″ OD, Length 4.65″
Inlet: ¼″ 18 NPT, Outlet ¼″ 18 NPT
Piston chamber ID: .370″, depth: .641″

### General Exemplary Specification:

Heater Cartridge connection: ½″ NPT conduit connection
Conduit adapter connection: ½″ NPT conduit connection to 360-degree swivel connection
Exemplary temp range for heater: NEC Class I Div 1 Group D with a temperature classification of T3 200 degrees C. (392 F).
Exemplary “wet gas” characteristics; Natural Gas with less than 2% entrained liquid

Exemplary fluid flow rate/range input/output: Typical analytical flow rates of approximately one to three Standard Liters per Minute of vapor with an inlet pressure of typically less than 4,000 PSIG and a regulated outlet pressure of typically less than 100 PSIG. Some gas chromatographs typically only need 50 cc/min vapor flow rate at 25 to 50 PSIG, but emerging optical analyzers including Tunable Diode Lasers require up to three L/min vapor flow rate at only 10 PSIG (low pressure due to glass optical analyzer cells).

### Recitation of Elements

D Phase diagram
R,′ prior art single, 4 stage regulator
V prior art genie vaporizer
1 SS vaporizing regulator
2 vaporizer body
3, ′, ″ length, first, second ends
4,′ upper, lower sections
5, generally cylindrical configuration, OD
6 regulator section
7 vaporizer section
8,′,″ conduit adapter section, cylindrical plug, socket
9, wrench flats
10, ′,″ threadingly connected
11,′ HC Base, threaded OD
12 heater cartridge section
13,′ Vaporizer first, second ends
14,′ length, longitudinal axis
15,′ opening, threaded sidewalls
16 receiver
17,′ ID, depth
18 end distal opening 15
19,′,″ HC Thermal conductive sleeve or jacket (AL), groove, O-rings
heater cartridge
21 receive
22,′ conductor sleeve OD, length
23 base wrench flat
24, “,” vaporization chamber, length, vaporization chamber (2nd embodiment)
25 space
26 conductor sleeve outer surface
27 mesh
28, fluid inlet, outlet
29 fluid flow
30 clearance between distal tip of conductor sleeve and distal end of receiver
31,′ post heat passage/outflow,
32 pivotal rotation
33, ′,″ inlet flow, vaporized sample pre regulation, flow from regulator,
34 post regulation heat exchange passage
35,′ adjustable regulator, spring biased seat2
36, piston, adjustment mechanism, helical compression spring
37 prior art systems
38 modular single-stage regulator
39 passage between third regulator and final adjustable regulator
40 Multi-Stage Vaporizing regulator
41 post heat passage
42,′ inlet, outlet
43,′,″ first, second, third piston chambers
44 threaded opening
45 threaded cover with O-ring or other seal
46, ′,″ modular regulator component
47,′ outer radial surface, radial plane
48 cylindrical body
49 inserted
50 adjustable regulator
51 post regulation heat exchange passage
52,′ vaporized, pressure reduced fluid
53,′ PTC heater cartridge, power connector
54 NTC heater cartridge
55,′,′ thermal cutoff, temp sensor, heater cartridge power
56 insulated enclosure
57 available space
58 center point
60 capillary flow path
61 sampling probe
62 vaporizer regulator
63 wet gas

The invention embodiments herein described are done so in detail for exemplary purposes only, and may be subject to many different variations in design, structure, application and operation methodology. Thus, the detailed disclosures therein should be interpreted in an illustrative, exemplary manner, and not in a limited sense.

1. A vaporizer regulator comprising:
a body having formed therein a receiver having an inner wall and an opening;
a heater cartridge having an outer wall, said vaporization cartridge formed to engage said receiver via said opening so as to form a vaporization chamber between said outer wall of said heater cartridge and said inner wall of said body;
an inlet formed in said body, said inlet formed to provide passage to said vaporization chamber;
a regulator formed to receive a flow from said vaporization chamber;
a post regulation heat exchange passage formed to receive flow from said regulator to a fluid outlet situated intermediate said regulator and said vaporizer;
wherein said body is formed of a thermally conductive material so as to conduct heat from said vaporization chamber to said post regulation heat exchange passage.

2. The vaporizer regulator of claim 1, wherein said heater cartridge is jacketed with a thermally conductive material.

3. The vaporizer regulator of claim 2, wherein said body has a length and a longitudinal axis, and wherein said regulator comprises a series of single-stage regulator components to provide multi-stage regulation of fluid flowing therethrough, each stage spaced an equal distance from the previous stage, and each stage accessible from the outer surface of said body, said series of single-stage regulator components being situated along a common plane perpendicular to the longitudinal axis of said body.

4. The vaporizer regulator of claim 3, wherein said series of single-stage regulator components comprise three regulators, and wherein there is further provided a fourth, adjustable regulator having an adjustment mechanism situated at an end of said body distal said vaporizer.

5. The vaporizer regulator of claim 4, wherein said multi-stage regulator is situated between said vaporizer and said adjustable regulator.

6. The vaporizer regulator of claim 5, wherein said three regulators comprising said multi-stage regulator comprise first, second and third regulator components situated in a series of first, second, and third piston chambers, respectively.

7. The vaporizer regulator of claim 6, wherein said first, second and third regulator components comprise modular regulator components formed to be inserted into said first, second and third piston chambers, respectively.

8. The vaporizer regulator of claim 7, wherein said body has a generally cylindrical configuration having an outer diameter, and wherein said series of single-stage regulator components are radially situated relative to one another from a common central point, along a common radial plane.

9. The vaporizer regulator of claim 8, wherein there is further provided a fluid passage from said third piston chamber to said fourth adjustable regulator, which fluid passage passes through said common central point.

10. The vaporizer regulator of claim 9, wherein said fluid comprises a wet gas sample, and wherein said inlet is formed to receive a flow of sample fluid via a capillary flow path from a sampling probe.

11. The vaporizer regulator of claim 10 wherein said heater cartridge has a base.

12. The vaporizer regulator of claim 11, wherein said base of said heater cartridge is threaded so as to threadingly engage said receiver of said vaporizer.

13. The vaporizer regulator of claim 12, wherein said heater cartridge comprises a positive temperature coefficient (PTC) heating element.

14. The vaporizer regulator of claim 13, wherein said base comprises an electrical connector for said positive temperature coefficient (PTC) heating element.

15. The vaporizer regulator of claim 12, wherein said heater cartridge comprises a negative temperature coefficient (NTC) heating element.

16. The vaporizer regulator of claim 15, wherein said heater cartridge comprises built-in thermal cutoff and temperature sensor.

17. The vaporizer regulator of claim 1, wherein said regulator comprises an adjustable regulator.

18. The vaporizer regulator of claim 17, wherein said fluid comprises a wet gas sample, and wherein said inlet is formed to receive a flow of sample fluid via a capillary flow path from a sampling probe.

19. A vaporizer regulator comprising:
a body having formed therein a receiver having an inner wall and an opening;
a heater cartridge having an outer wall, said vaporization cartridge formed to engage said receiver via said opening so as to form a vaporization chamber between said outer wall of said heater cartridge and said inner wall of said body;
an inlet formed in said body, said inlet formed to provide passage to said vaporization chamber;
a regulator formed to receive a flow from said vaporization chamber;
a post regulation heat exchange passage formed to receive flow from said regulator to a fluid outlet;
wherein said body has a length and a longitudinal axis, and wherein said regulator comprises a series of single-stage regulator components, each stage spaced an equal distance from the previous stage, and each stage accessible from the outer surface of said body, said series of single-stage regulator components being situated along a common plane perpendicular to the longitudinal axis of said body.

20. The vaporizer regulator of claim 19, wherein said series of single-stage regulator components comprises three regulators, and wherein there is further provided a fourth, adjustable regulator having an adjustment mechanism situated at an end of said body distal said vaporizer.

21. The vaporizer regulator of claim 20, wherein said multi-stage regulator is situated between said vaporizer and said adjustable regulator.

22. The vaporizer regulator of claim 21, wherein said three regulators comprising said multi-stage regulator comprise first, second and third regulator components situated in a series of first, second, and third piston chambers, respectively.

23. The vaporizer regulator of claim 22, wherein said first, second and third regulator components comprise modular regulator components formed to be inserted into said first, second and third piston chambers, respectively.

24. The vaporizer regulator of claim 23, wherein said body has a generally cylindrical configuration having an outer diameter, and wherein said series of single-stage regulator components are radially situated relative to one another from a common central point, along a common radial plane.

25. The vaporizer regulator of claim 24, wherein there is further provided a fluid passage from said third piston chamber to said fourth adjustable regulator, which fluid passage passes through said common central point.

26. The vaporizer regulator of claim 25, wherein said fluid comprises a wet gas sample, and wherein said inlet is formed to receive a flow of sample fluid via a capillary flow path from a sampling probe.

27. The vaporizer regulator of claim 26 wherein said heater cartridge has a base.

28. The vaporizer regulator of claim 27, wherein said base of said heater cartridge is threaded so as to threadingly engage said receiver of said vaporizer.

29. The vaporizer regulator of claim 28, wherein said heater cartridge comprises a positive temperature coefficient (PTC) heating element.

30. The vaporizer regulator of claim 28, wherein said heater cartridge comprises a negative temperature coefficient (NTC) heating element.

31. The vaporizer regulator of claim 30, wherein said heater cartridge comprises built-in thermal cutoff and temperature sensor.

32. A method of conditioning a wet gas, comprising the steps of:
a. providing a vaporizer regulator comprising a body of thermally conductive material having formed therein a receiver having an inner wall and an opening;
b. inserting a heater cartridge having an outer wall into said receiver, forming a vaporization chamber between said outer wall of said heater cartridge and said inner wall of said body
c. flowing a wet gas to said wet gas to said vaporization chamber, providing heat to said vaporization chamber via said heater cartridge, vaporizing said wet gas, providing vaporized fluid;
d. flowing said vaporized fluid to a first regulator, providing post-regulated fluid;
e. utilizing said thermally conductive material comprising said body to conduct heat from said vaporization chamber to a post regulation heat exchange passage, providing a heated post regulation heat exchange passage; while
f. flowing said post-regulated fluid from said first regulator to an outlet via said heated post regulation heat exchange passage.

33. A method of conditioning a wet gas, comprising the steps of:
a. providing a vaporizer regulator comprising a body having an outer surface, a length, and a longitudinal axis, said body formed of thermally conductive material, said body further having formed therein a receiver having an inner wall and an opening;
b. providing a heater cartridge having an outer wall in said receiver, forming a vaporization chamber between said outer wall of said heater cartridge and said inner wall of said body;
C. flowing a wet gas to said vaporization chamber, providing heat to said vaporization chamber via said heater cartridge to vaporize said wet gas, providing vaporized fluid;
d. flowing said vaporized fluid through a series of single-stage regulator components, each component spaced an equal distance from the previous stage, such that each said regulator component forming each stage is accessible from the outer surface of said body, while;
e. situating said series of single-stage regulator components being along a common plane perpendicular to said longitudinal axis of said body adjacent to said vaporizer chamber;
f. thermally conducting said heat from said vaporization chamber via said body to said series of single-stage regulators, providing uniformly heated regulators; and
g. utilizing said uniformly heated regulators to provide stepped regulation of said fluid so as to avoid Joule-Thomson effect condensation, providing JT regulated fluid.

34. The method of claim 33, wherein there is further provided after step “g” the added steps of:
h. flowing said JT regulated fluid through a final adjustable regulator;
i. flowing said JT regulated fluid through a post regulation heat exchange passage to a fluid outlet situated intermediate said final adjustable regulator and said vaporizer; while
j. transferring heat via said thermally conductive material forming said body from said vaporization chamber to said post regulation heat exchange passage to post condition said JT regulated fluid.

35. A multi-stage regulator comprising:
a body having first and second ends forming a length and a longitudinal axis, said body further comprising an outer surface,
a plurality of piston chambers formed in said body, said piston chambers situated along a common plane perpendicular to said longitudinal axis in a radially-situated configuration, each one of said piston chambers linked in serial fashion to an adjacent piston chamber so as to provide a series of linked piston chambers comprising first and last serially-linked piston chambers, each of said piston chambers having a sealable opening accessible via said outer surface of said body;
an inlet comprising a first flow passage to said first serially-linked piston chamber, and a flow passage from said last serially-linked piston chamber;
each said piston chamber formed to receive a modular regulator component via said respective sealable opening, each said modular regulator component selected from a collection of modular regulator components having various fluid regulating characteristics, each said conditioning component formed for insertion into and containment via said respective piston chambers and respective sealable opening;
whereby, upon inserting said condition components into said piston chambers and sealing said piston chambers via respective said sealable openings, providing piston chambers having said selected modular regulator components sealed therein respectively in a desired order, and facilitating serial flow of fluid therethrough, there is provided a staged conditioning of fluid flowing therethrough via said modular regulator components.

36. The regulator of claim 35, wherein one or more of said modular regulator components comprise single-stage regulators.

37. The regulator of claim 36 wherein there is provided a flow passage from said last serially-linked piston chamber to an adjustable regulator having an adjustment mechanism engaging said body, said adjustable regulator providing adjustably regulated flow to fluid flowing therethrough to a post regulator passage.

38. The regulator of claim 37, wherein said regulator body has a generally cylindrical configuration having an outer surface forming an outer diameter, and wherein said sealable openings of said serially linked piston chambers are situated along said outer surface of said body.

39. The regulator of claim 38, wherein said fluid comprises a gas having entrained liquid, and wherein said inlet is formed to receive a flow of sample fluid via a capillary flow path from a sampling probe.

40. A method of conditioning a wet gas, comprising the steps of:
a. providing multi-stage regulator comprising a body having an outer surface, a length, and a longitudinal axis, said body formed of thermally conductive material, said body further comprising a plurality of piston chambers, said piston chambers linked in serial fashion, providing a series of linked piston chambers comprising first and last serially-linked piston chambers, each of said piston chambers formed to provide an opening accessible via said outer surface of said body, said serially-linked piston chambers configured to provide an order of flow from one of said piston chambers to the other;
b. selecting from a collection of modular regulator components having defined fluid regulating characteristics to provide a predetermined order of components to facilitate staged conditioning of said wet gas;
c. placing said modular regulator components in said predetermined order in said serially-linked piston chambers beginning with said first piston chamber, such that a single modular regulator component is placed in a single piston chamber in the desired order of flow, providing piston chambers having a modular regulator component situated therein, providing a series of linked modular regulator components;
d. sealing said openings of said piston chambers;
e. flowing said wet gas fluid through said series of modular regulator components situated in said serially-linked piston chambers; while
f. utilizing said modular regulator components to provide stepped regulation of said wet gas flowing therethrough so as to prevent Joule-Thomson effect condensation, providing JT regulated, pressure-reduced wet gas.

41. The method of claim 40, wherein there is further provided after step “f” the added steps of:
g. flowing said JT regulated fluid through a final adjustable regulator;
h. flowing said JT regulated fluid through a post regulation passage to a fluid outlet.

42. The method of claim 40, wherein in step “a”, there is provided the additional step a. (i) of situating said piston chambers in said body along a common plane perpendicular to said longitudinal axis of said body in a radially-situated configuration.
